(19) United States
(12) Patent Application Publication
(10) Pub. No.: US 2011/0030295 A1
(43) Pub. Date: Feb. 10, 2011

(54) BLAST-RESISTANT GLAZING SYSTEM

(75) Inventor: Jonathan Morley, Wraysbury (GB)

Correspondence Address: Setter Roche LLP, P.O. Box 780, Erie, CO, 80516, US

(73) Assignee: Trueform Engineering Limited, Hayes (GB)

(21) Appl. No.: 12/851,067

(22) Filed: Aug. 5, 2010

(30) Foreign Application Priority Data
Aug. 7, 2009 (GB) 0913933.8

(51) Int. Cl. E06B 3/988; E04B 1/00

(52) U.S. Cl. 52/204.7; 52/745.15

(57) ABSTRACT

A blast-resistant glazing system comprises a sheet of blast-resistant glazing material, such as laminated glass, and an elongate retaining member. The retaining member has two spaced opposed lips for receiving an edge region of the glazing sheet therebetween. Each one of the lips lies adjacent a respective one of the major surfaces of the sheet. The glazing sheet is provided with a respective outwardly extending projection on each major surface of the sheet. Each projection interlocks with a respective one of the lips so that withdrawal of the edge region of the sheet from between the lips is resisted by engagement between the projections and the lips.

### RELATED APPLICATIONS

This application is related to and claims priority to Great Britain (GB) Application No. 0913933.8, entitled “Blast-Resistant Glazing System,” filed on Aug. 7, 2009, which is hereby incorporated by reference in its entirety.

### TECHNICAL FIELD

Aspects of the invention are related, in general, to the field of blast-resistant systems, and more specifically, to blast-resistant glazing systems.

### TECHNICAL BACKGROUND

It is often desirable to provide blast-resistant glazing in buildings, vehicles, and other structures such as shelters (e.g., bus shelters) and walls or partitions. Sheets of glazing material that are highly resistant to bomb blasts are known. One such material is specialized laminated glass.

In operation, it is necessary to mount the glazing material to the building, structure, vehicle, etc., in a manner so that the glazing material does not break loose during a bomb blast or other explosion, and for this purpose one or more retaining members may be used. Each retaining member is secured to the building, structure, vehicle etc by suitable fastening means and the sheet of glazing material is mounted in the retaining member or members. For example, for a rectangular sheet of glazing material, each of two opposed edge regions of the sheet may be mounted in a respective retaining member.

A known blast-resistant glazing system comprises a sheet of blast-resistant laminated glass and a retaining member in the form of an aluminium bar having a rebate (i.e. a U-sectioned slot) extending therealong. In order to mount the glass sheet in the retaining member, an edge region of the glass sheet is inserted into the rebate and then silicone is injected into the gaps between the glass sheet and the surfaces of the rebate. Once the silicone has cured, it forms a strong bond between the glass sheet and the retaining member.

However, this known glazing system suffers from a number of problems. First, the surfaces of the edge region of the glass sheet and the surfaces of the rebate need to be carefully cleaned and primed to ensure satisfactory adhesion by the silicone, and it may be difficult to achieve this if the mounting is performed “on site.” Moreover, it is also difficult to ensure that the silicone has filled all the gaps between the edge region of the glass and the surfaces of the rebate. Insufficient filling can lead to insufficient adhesion. Further, the silicone takes a long time (days or weeks) to fully cure the adhesion between the retaining member and the glass sheet. The glass sheet is weaker during this curing period and the final strength of the adhesion may be reduced if the glass sheet is inadvertently moved during the curing process. For example, the wind or members of the public may inadvertently move the glass sheet during the curing process. Furthermore, if a glass sheet is damaged, replacement is onerous as the cured silicone needs to be removed completely from the rebate and the rebate surfaces cleaned thoroughly before a replacement glass sheet can be fitted.

### OVERVIEW

In an embodiment, a blast-resistant glazing system is disclosed. The blast-resistant glazing system comprises a sheet of blast-resistant glazing material, and a retaining member having two spaced opposed portions for receiving an edge region of the sheet therebetween with each one of the portions lying adjacent a respective major surface of the sheet. In this system, the sheet and the retaining member are provided with respective formations extending at respective angles relative to the major surfaces of the sheet so that withdrawal of the edge region of the sheet from between the portions is resisted by engagement between the formations.

In another embodiment, the formation provided to the sheet comprises a projection extending outwardly from one of the major surfaces of the sheet.

In another embodiment, the projection further comprises an adhesive layer and a projection member adhered to the one of the major surfaces of the sheet by the adhesive layer.

In another embodiment, the adhesive layer comprises a layer of silicone.

In another embodiment, the adhesive layer comprises Very High Bond (VHB) tape.

In another embodiment, the projection member comprises a sheet of metal.

In another embodiment, the adhesive layer is at least 5 mm thick.

In another embodiment, the VHB tape comprises VHB acrylic foamed tape.

In another embodiment, the formation provided to the retaining member comprises a surface of one of the portions of the retaining member.

In another embodiment, the retaining member has open and closed configurations to allow the edge region of the sheet to be positioned between the portions when the retaining member is in the open configuration, and for holding the formations in an interlocking relationship with one another when the edge region of the sheet is received between the portions and the retaining member is in the closed configuration.

In another embodiment, the edge region of the sheet is received between the portions of the retaining member, a limited amount of movement of the sheet in a direction tending to withdraw the edge region from between the portions is allowed before the formations engage to resist withdrawal, and the retaining member operates as a clamp so as to promote friction which resists the limited movement before engagement of the formations.

In another embodiment, there is no adhesive bond between the sheet and the retaining member.

In another embodiment, the retaining member is elongated and the opposed portions extend along the length of the retaining member to form a slot therebetween.

In another embodiment, the retaining member comprises two elongated parts and a securing means for securing the two parts together, each one of the opposed portions have an inwardly directed lip on a respective one of the two parts, and each part has a respective recess located adjacent the corresponding lip, wherein the sheet has a respective projection extending outwardly from each major surface at the edge region of the sheet, the sheet being positionable so that the edge region of the sheet passes through the slot between the lips with each projection being received in a respective one of the recesses so as to be interlocked with a respective one of the lips to resist withdrawal of the edge region of the sheet from the retaining member.

In another embodiment, the sheet comprises a sheet of laminated glass.

In yet another embodiment, a blast-resistant glazing system is disclosed. The blast-resistant glazing system comprises a sheet of blast-resistant glazing material, and a retaining member. The retaining member having two spaced opposed portions for receiving an edge region of the sheet therebetween so that each portion lies adjacent a respective major surface of the sheet. The sheet is provided with a projection extending outwardly from one of the major surfaces and the projection interlocks with one of the portions so that withdrawal of the edge region of the sheet from between the portions is resisted by engagement between the projection and the one of the portions.

In another embodiment, the projection provided to the sheet comprises an adhesive layer and a projection member, the projection member being adhered to the one of the major surfaces of the sheet by the adhesive layer.

In another embodiment, the retaining member has open and closed configurations to allow the edge region of the sheet to be positioned between the portions when the retaining member is in the open configuration, and for holding the projection provided to the sheet in an interlocking relationship with the one of the portions when the edge region of the sheet is received between the portions and the retaining member is in the closed configuration.

In another embodiment, when the edge region of the sheet is received between the portions of the retaining member, a limited amount of movement of the sheet in a direction tending to withdraw the edge region from between the portions is allowed before the projection provided to the sheet engages the one of the portions to resist withdrawal, and wherein the retaining member operates as a clamp so as to promote friction which resists the limited movement before the engagement.

In another embodiment, there is no adhesive bond between the sheet and the retaining member.

### BRIEF DESCRIPTION OF THE DRAWINGS

FIG. 1 illustrates a cross-sectional view of a blast-resistant glazing system in an exemplary embodiment.

FIG. 2 illustrates a cross-sectional view of a blast-resistant glazing system in another exemplary embodiment.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

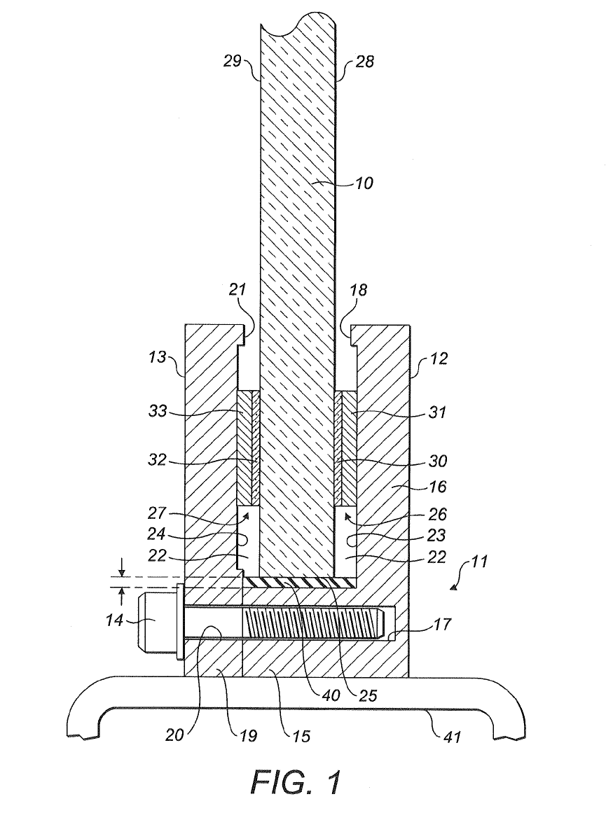

Advantageously, the disclosed blast-resistant glazing overcomes the shortcomings of the prior art. Referring first to FIG. 1, which illustrates a cross-sectional view of a blast-resistant glazing system in an exemplary embodiment. Those skilled in the art will appreciate that elements

The glazing system comprises a sheet 10 of blast-resistant laminated glass and an elongate retaining member 11. The retaining member 11 has a first elongate part 12 and a second elongate part 13 held together parallel to one another by a plurality of bolts 14 which are spaced along the length of the retaining member 11.

The first part 12 is generally L-shaped in section with a base 15 and an arm 16 meeting each other at 90 degrees. The base 15 is provided with a plurality of threaded blind holes 17, which are spaced from each other along the base 15, and which extend into the base 15 from the free end of the base 15. The free end of the arm 16 is provided with a lip 18, which extends the full length of the arm 16, and which extends from the arm 16 parallel to and in the same direction as the base 15.

The second part 13 is generally planar and has a thickened base edge 19 which is provided with a plurality of through holes 20 spaced along the length of the second part 13. Opposite to the base edge 19, the second part 13 is provided with a lip 21 which extends the full length of the second part 13 and which extends at 90 degrees to the plane of the second part 13.

As shown in FIG. 1, the first and second parts 12, 13 are assembled together with the thickened base edge 19 of the second part abutting the free end of the base 15 of the first part 12. Each through hole 20 is aligned with a respective one of the threaded blind holes 17 and a respective bolt 14 passes through the through hole 20 and is threadedly engaged with the threaded blind hole 17. The arm 16 of the first part 12 lies parallel to and opposite the second part 13 so that a generally U-sectioned channel or rebate 22 is formed between the first and second parts 12, 13.

The lip 18 on the first part 12 and the lip 21 on the second part 13 extend towards one another to form a slot therebetween, located at the mouth of the U-sectioned rebate 22.

A first recess 23 is provided in the U-sectioned rebate 22, on the first part 12, between the lip 18 and the base 15, and a second recess 24 is provided in the U-sectioned rebate 22, on the second part 13, between the lip 21 and the thickened base edge 19. A rubber spacer 40 resides at the base of the rebate 22 adjacent the base 15 of the first part 12.

The laminated glass sheet 10 is rectangular with one edge 25 shown in FIG. 1. A respective projection 26, 27 is provided on each one of the two opposed major surfaces 28, 29 of the glass sheet 10 adjacent the edge 25 of the sheet 10. The two projections 26, 27 are identical and only one will be described in detail.

The projection 26 extends the full length of and parallel to the edge 25 of the glass sheet 10. The projection 26 has a first layer consisting of a strip of very high bond (VHB) tape 30. A preferred tape is 25 mm wide 4918F VHB acrylic foamed tape supplied by 3M Ltd. One side of the VHB tape is adhered to the major surface 28 of the glass sheet 10 at the edge region. The other side of the VHB tape 30 is adhered to a strip of aluminium 31, which forms a second outer layer of the projection 26. The VHB tape 30 is about 2 mm thick and the aluminium strip 31 is about 3 mm thick. In FIG. 1 the other projection 27 is shown with a strip of VHB tape 32 and a strip of aluminium 33.

The retaining member 11 may be used to mount the sheet of laminated glass 10 to a building, or to a structure such as a glass wall, a partition or a shelter (e.g., a bus shelter). Part of the building or structure is shown at 41. In general, for rectangular sheets 10, either two or four retaining members 11 will be used. When two retaining members 11 are used, they are used, respectively, to mount opposed edge regions of the sheet 10. When four retaining members 11 are used, each retaining member 11 is used to mount a respective edge of the sheet 10. Each retaining member 11 is secured to the building, structure 41 etc using suitable retaining means such as bolts (not shown).

In order to mount the glass sheet 10 in a retaining member 11, the bolts 14 are loosened and the second part 13 is pulled away from the first part 12 so as to increase the width of the slot between the first part lip 18 and the second part lip 21. The edge region of the sheet 10 is then inserted between the first and second parts 12, 13 until the projections 26, 27 have passed beyond the lips 18, 21 and until the edge 25 of the glass sheet 10 lies against the rubber spacer 40. The bolts 14 are then tightened so that the thickened base edge 19 of the second part 13 abuts the base 15 of the first part 12.

After the bolts 14 have been tightened, the projection 26 lies in the recess 23 in the first part 12 and the projection 27, on the other major surface of the sheet 10, lies in the recess 24 in the second part 13. Hence, the projection 26 is interlocked with the lip 18 on the first part 12 and the projection 27 is interlocked with the lip 21 on the second part 13.

The dimensions of the first and second parts 12,13, the thickness of the glass sheet 10 and the thicknesses of the two layers of very high bond tape 30, 32 and the two strips of aluminium 31, 33 are such that the edge region of the glass sheet 10 with the two projections 26, 27 is clamped between the two parts 12, 13. The strips of VHB tape 30, 32 are compressed by about 10%.

As seen in FIG. 1 there is a gap between each one of the two projections 26, 27 and the corresponding one of the two lips 18, 21 with which that projection 26, 27 is interlocked.

In a bomb blast, the force of the blast will generally act on one or the other of the major surfaces 28, 29 of the glass sheet 10. Assuming that the glass sheet 10 is held at two opposed edges by two retaining members 11, as discussed above, the glass sheet 10 tends to bend between the two retaining members 11 and this, in turn, tends to withdraw the edge regions of the glass sheet 10 from the retaining members 11. This withdrawal is resisted by two mechanisms.

Firstly, as the edge region of the glass sheet 10 is clamped between the first and second parts 12, 13, withdrawal of the edge region is resisted by friction between the aluminium strips 31, 33 and the first and second parts 12, 13—as the projections 26, 27 move towards the lips 18, 21. Secondly, the aluminium strip 31 of the projection 26 engages the lip 18 and the aluminium strip 33 of the projection 27 engages the lip 21. The engagement between the projections 26, 27 and the lips 18, 21 prevents further withdrawal of the edge region of the glass sheet 10 from the retaining member 11.

The adhesion of the VHB tape 30, 32 to the glass sheet 10 and also to the aluminium strips 31, 33 can be readily carried out under factory conditions—where the surfaces can be carefully cleaned and curing of the VHB tape 30, 32 can be carried out under controlled conditions (eg of temperature and humidity). Adhesion is preferably carried out in accordance with the instructions of the manufacturer of the VHB tape. In this way, optimum bonding can be achieved. The glass sheet 10, with all the necessary projections 26, 27 already formed thereon can then be taken to the building or structure where it is to be used and mounted within the retaining members 11 as described above.

Advantageously, the process of mounting the glass sheet 10 (with pre-formed projections 26, 27) into the retaining members 11 is a simple mechanical process and does not require adhesion between the glass sheet 10 and the retaining members 11. It can be carried out readily on site by personnel with no experience of silicone bonding. Unlike the conventional blast-resistant glazing system described above, which requires formation of a silicone bond between the glass and the retaining members, there is no risk of insufficient bonding due to incomplete filling of the gaps between the glass and the rebate with silicone, no risk of inadequate bonding caused by dirty surfaces and no risk of weakening of the bond by movement of the glass sheet during curing.

Moreover, if the bonding of the VHB tape 30, 32 is performed in the factory, before the glass 10 is mounted to the building or structure, the glazing system provides full blast protection as soon as the glass 10 is mounted in the retaining members 11. This is a significant improvement over the conventional silicone bonding system in which full protection is not achieved for days or weeks until the curing of the silicone is completed.

Furthermore, replacement of glass sheets 10 is rapid and easy. As there is no bonding between the retaining members 11 and the glass sheet 10 there is no need to remove previous bonding material (such as silicone in the conventional system) and no need to clean the surfaces of the retaining member. In order to replace a glass sheet 10, the bolts 14 are loosened, the second part 13 is separated from the first part 12 and the old glass sheet 10 is removed. A new glass sheet 10 is then mounted in the retaining members 11 as described above.

A further advantage is that the glazing system can accommodate different thicknesses of blast resistant glass sheet with minimal modification. For glass sheets 10 that are thinner, the thickness of the aluminium strips 31, 33 can be increased so that the glass sheet 10 with the projections 26, 27 is still clamped between the first and second parts 12, 13. When it is desired to use a thicker glass sheet, the aluminium strips 31, 33 can be made thinner. Alternatively, the gap between the arm 16 of the first part 12 and the second part 13 can be increased by inserting a spacer or spacers (not shown in FIG. 1) between the thickened base edge 19 of the second part 13 and the base 15 of the first part 12.

Although the embodiment described above with reference to FIG. 1 has a respective projection 26, 27 on each side of the glass sheet 10, each of which interlocking with a respective lip 18, 21, this is not necessary. A single projection interlocking with a single lip could be used. It is also not necessary to use projections 26, 27 and lips 18, 21, as described above. All that is required is a formation on the glass sheet and a cooperating formation on the retaining member, the formations resisting withdrawal of the glass sheet from the retaining member by engagement between themselves.

In order to achieve this, the formations will need some degree of extension in respective directions that are not parallel to the direction of withdrawal of the glass sheet from the rebate (the withdrawal direction will generally be parallel to the major surfaces of the glass sheet). In a less preferred embodiment the retaining member is provided with a projection which interlocks with a groove on the glass sheet—although this is less desirable as the groove may weaken the glass sheet.

As described above, it is preferred for the formations to be interlocked but not actually in engagement with one another, in the normal position of the glass sheet. This allows for some blast energy to be absorbed by friction as the glass sheet moves relative to the retaining member and before the formations come into engagement. However, this is not essential and the formations may be in engagement in the normal position of the glass sheet. Although clamping of the glass sheet by the retaining member is useful as it generates friction as the formations move into engagement, clamping is also not essential and the glass sheet may be loosely received in the retaining member—as long as the formations are held in interlocking relationship so that they are either engaged or come into engagement to resist withdrawal of the glass sheet.

In the embodiment described above with reference to FIG. 1, the VHB tape 30, 32 serves as an adhesive layer between the glass sheet 10 and the aluminium strips 31, 33. Other types of adhesive layer may be used.

Those skilled in the art will appreciated that various modifications may be made to the invention. For example, those skilled in the art will appreciate that it is not necessary to use laminated glass sheets and other blast-resistant glazing materials. That is, in some embodiments, polycarbonate sheets may be used.

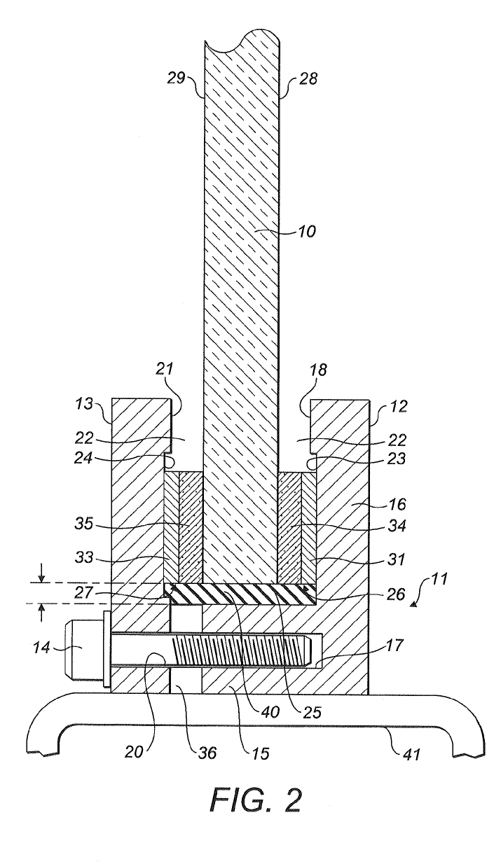

FIG. 2 illustrates a cross-sectional view of a blast-resistant glazing system in another exemplary embodiment. Elements of this embodiment may be identical or similar to corresponding parts of the FIG. 1 embodiment. These elements are given the same reference numerals and will not be described in detail.

In the second embodiment, each strip of VHB tape 30, 32 used in the first embodiment is replaced by a strip of structural silicone 34, 35. A suitable type of structural silicone is available from Dow Corning as 995 silicone. Each strip 34, 35 of structural silicone has a thickness of about 6 mm (before clamping between the first and second parts 12, 13). As the structural silicone 34, 35 is thicker than the VHB tape 30, 32 a spacer 36 is placed between the first and second parts 12, 13.

In order to form a structural silicone strip 34, 35, the silicone is applied to the glass sheet 10, after cleaning and priming of the glass sheet, in a clean environment maintained at a suitable temperature and humidity. The aluminium strip 31, 33, again cleaned and primed, is then applied to the outside of the silicone. The silicone is then left to cure completely in the clean environment. Cleaning, priming and curing are preferably carried out in accordance with the instructions of the manufacturer of the silicone. After curing of the silicone, each silicone strip 34, 35 together with the associated aluminium strip 31, 33 makes up a projection that interlocks with one of the lips 18, 21, in the same way as described above in respect of the first embodiment.

The blast-proof glazing system of the current invention is suitable for use, for example, in buildings; other structures such as bus shelters, partitions, walls etc; as well as in transport means such as ships and vehicles etc.

Bus shelters using the current blast-proof glazing system were tested for resistance to bomb blasts according to the ISO/FDIS 16933 EXV 25 standard. This involves submitting the bus shelter to the equivalent of a 100 kg TNT car bomb with a distance of 25 m between the explosive and the bus shelter. Two bus shelters were tested. The first shelter used 13.5 mm thick laminated glass sheets and also 17.5 mm thick laminated glass sheets mounted to a strong bus shelter frame using the glazing system of the FIG. 1 embodiment (using VHB tape 30, 32 as the adhesive layer). The second bus shelter also used 13.5 mm laminated glass sheets and 17.5 mm laminated glass sheets mounted to a strong bus shelter frame, this time using the glazing system of the FIG. 2 embodiment (using the structural silicone strips 34, 35). Each glass sheet, in both bus shelters, was mounted using two retaining members—one at the top and one at the bottom.

The blast-resistant glazing system performed well and all of the glass sheets were retained by the bus shelter frames—ie none of the glass sheets broke free. The glazing system of the second bus shelter (using silicone strips 34, 35 as the adhesive layer) was considered to perform slightly better than the glazing system of the first bus shelter (using VHB tape strips 30, 32 as the adhesive layer). This is because whereas a degree of loosening of the glass 10 in the retaining members 11 was observed after the blast, when VHB tape 30, 32 was used, no such loosening was observed when silicone strips 34, 35 were used.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A blast-resistant glazing system comprising:
a sheet of blast-resistant glazing material; and
a retaining member having two spaced opposed portions for receiving an edge region of the sheet therebetween with each one of the portions lying adjacent a respective major surface of the sheet;
wherein the sheet and the retaining member are provided with respective formations extending at respective angles relative to the major surfaces of the sheet so that withdrawal of the edge region of the sheet from between the portions is resisted by engagement between the formations.

2. The blast-resistant glazing system of claim 1, wherein the formation provided to the sheet comprises a projection extending outwardly from one of the major surfaces of the sheet.

3. The blast-resistant glazing system of claim 2, wherein the projection further comprises an adhesive layer and a projection member adhered to the one of the major surfaces of the sheet by the adhesive layer.

4. The blast-resistant glazing system of claim 3, wherein the adhesive layer comprises a layer of silicone.

5. The blast-resistant glazing system of claim 3, wherein the adhesive layer comprises Very High Bond (VHB) tape.

6. The blast-resistant glazing system of claim 3, wherein the projection member comprises a sheet of metal.

7. The blast-resistant glazing system of claim 4, wherein the adhesive layer is at least 5 mm thick.

8. The blast-resistant glazing system of claim 5, wherein the VHB tape comprises VHB acrylic foamed tape.

9. The blast-resistant glazing system of claim 1, wherein the formation provided to the retaining member comprises a surface of one of the portions of the retaining member.

10. The blast-resistant glazing system of claim 1, wherein the retaining member has open and closed configurations to allow the edge region of the sheet to be positioned between the portions when the retaining member is in the open configuration, and for holding the formations in an interlocking relationship with one another when the edge region of the sheet is received between the portions and the retaining member is in the closed configuration.

11. The blast-resistant glazing system of claim 1, wherein when the edge region of the sheet is received between the portions of the retaining member, a limited amount of movement of the sheet in a direction tending to withdraw the edge region from between the portions is allowed before the formations engage to resist withdrawal, and the retaining member operates as a clamp so as to promote friction which resists the limited movement before engagement of the formations.

12. The blast-resistant glazing system of claim 1, wherein there is no adhesive bond between the sheet and the retaining member.

13. The blast-resistant glazing system of claim 1, wherein the retaining member is elongated and the opposed portions extend along the length of the retaining member to form a slot therebetween.

14. The blast-resistant glazing system of claim 13, wherein the retaining member comprises two elongated parts and a securing means for securing the two parts together, each one of the opposed portions have an inwardly directed lip on a respective one of the two parts, and each part has a respective recess located adjacent the corresponding lip, wherein the sheet has a respective projection extending outwardly from each major surface at the edge region of the sheet, the sheet being positionable so that the edge region of the sheet passes through the slot between the lips with each projection being received in a respective one of the recesses so as to be interlocked with a respective one of the lips to resist withdrawal of the edge region of the sheet from the retaining member.

15. The blast-resistant glazing system of claim 1, wherein the sheet comprises a sheet of laminated glass.

16. A blast-resistant glazing system comprising:
a sheet of blast-resistant glazing material; and
a retaining member, the retaining member having two spaced opposed portions for receiving an edge region of the sheet therebetween so that each portion lies adjacent a respective major surface of the sheet;
wherein the sheet is provided with a projection extending outwardly from one of the major surfaces and the projection interlocks with one of the portions so that withdrawal of the edge region of the sheet from between the portions is resisted by engagement between the projection and the one of the portions.

17. The blast-resistant glazing system of claim 16, wherein the projection provided to the sheet comprises an adhesive layer and a projection member, the projection member being adhered to the one of the major surfaces of the sheet by the adhesive layer.

18. The blast-resistant glazing system of claim 16, wherein the retaining member has open and closed configurations to allow the edge region of the sheet to be positioned between the portions when the retaining member is in the open configuration, and for holding the projection provided to the sheet in an interlocking relationship with the one of the portions when the edge region of the sheet is received between the portions and the retaining member is in the closed configuration.

19. The blast-resistant glazing system of claim 16, wherein when the edge region of the sheet is received between the portions of the retaining member, a limited amount of movement of the sheet in a direction tending to withdraw the edge region from between the portions is allowed before the projection provided to the sheet engages the one of the portions to resist withdrawal, and wherein the retaining member operates as a clamp so as to promote friction which resists the limited movement before the engagement.

20. The blast-resistant glazing system of claim 16, wherein there is no adhesive bond between the sheet and the retaining member.

21. A method of installing a blast-resistant glazing system comprising a sheet of blast-resistant glazing material and a retaining member having two spaced opposed portions for receiving an edge region of the sheet therebetween with each one of the portions lying adjacent a respective major surface of the sheet, the method comprising
securing
wherein the sheet and the retaining member are provided with respective formations extending at respective angles relative to the major surfaces of the sheet so that withdrawal of the edge region of the sheet from between the portions is resisted by engagement between the formations.
